(19) United States
(12) Patent Application Publication
(10) Pub. No.: US 2019/0387841 A1
(43) Pub. Date: Dec. 26, 2019

(54) MACHINE FOR VAMP SHAPING

(71) Applicant: TRUE TEN INDUSTRIAL CO., LTD., Taichung City (TW)

(72) Inventor: Chiao-Chung LIN, Taichung City (TW)

(73) Assignee: TRUE TEN INDUSTRIAL CO., LTD., Taichung City (TW)

(21) Appl. No.: 16/013,444

(22) Filed: Jun. 20, 2018

(51) Int. Cl. A43D 11/12; B29D 35/12

(52) U.S. Cl. CPC A43D 11/12; B29D 35/128; B29D 35/126

(57) ABSTRACT

A machine for vamp shaping has a body, at least one vertical device, and at least one horizontal device. The at least one vertical device and the at least one horizontal device are mounted to the body, respectively. A vamp may be made with a toe-cap shaping process through a toe-cap inner mold and a toe-cap outer mold of the at least one vertical device, and further be processed with a heel-cap shaping process through a heel-cap inner mold and a heel-cap outer mold of the at least one horizontal device. As a result, the machine not only enables workers to easily accomplish the toe-cap shaping and the heel-cap shaping of the vamp, but also is applicable in a limited space.

### BACKGROUND OF THE INVENTION

### 1. Field of the Invention

The present invention relates to a machine for vamp shaping, and more particularly to a machine for both toe-cap and heel-cap shaping with high efficiency.

### 2. Description of Related Art

To form a vamp into a curved surface so that the vamp can wrap and cover the foot, a toe-cap shaping operation and a heel-cap shaping operation are both necessary in procedures of shoe-making.

Conventional techniques for the toe-cap and the heel-cap shaping operations are separately done with a toe-cap shaping machine and a heel-cap shaping machine, respectively. To perform the shaping operations, a vamp should be firstly processed on the toe-cap shaping machine to form a toe cap, and then be transferred to the heel-cap shaping machine to complete a heel cap.

According to the above, the present techniques have the following shortcomings.

1. A shoemaker must purchase the two sorts of shaping machines; otherwise either a toe cap or a heel cap cannot be formed. That increases space occupation in a factory and facility equipment cost for the shoemaker.

2. Moreover, workers have to learn to operate the two sorts of shaping machines. That results in high complexity of machine operation and low working efficiency.

### SUMMARY OF THE INVENTION

The main objective of the present invention is to provide a machine for vamp shaping which is able to form both a toe cap and a heel cap for a shoe.

The machine for vamp shaping comprises a body, at least one vertical device, and at least one horizontal device. The body has at least two vertical holes and at least two horizontal holes. The at least one vertical device is mounted to the body via the at least two vertical holes, and each vertical device has a toe-cap inner mold, a vamp locating module, and a toe-cap upper module. The toe-cap inner mold is mounted to the body. The vamp locating module is movably mounted to the at least two vertical holes and located near the top-cap inner mold. The toe-cap upper module is movably mounted to the vamp locating module and is located above the toe-cap inner mold. The at least one horizontal device is mounted to the body via the at least two horizontal holes, and each horizontal device has a heel-cap inner module and a heel-cap outer module. The heel-cap inner module is movably mounted to the at least two horizontal holes. The heel-cap outer module is movably mounted to the heel-cap inner module and is located beside the heel-cap inner module and away from the body.

A vamp may be manufactured with a toe-cap shaping process through the toe-cap inner mold and the toe-cap upper module, and further be processed with a heel-cap shaping process through the heel-cap inner module and the heel-cap outer module. As a result, the machine not only enables workers to easily accomplish the toe-cap shaping and the heel-cap shaping of the vamp, but also is applicable in a limited space.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a machine for vamp shaping in accordance with the present invention;

FIG. 2 is another perspective view of the machine for vamp shaping in FIG. 1;

FIG. 3 is a front side view in partial section of the machine for vamp shaping in FIG. 1;

FIG. 4 is a side view in partial section of the machine for vamp shaping along a line A-A in FIG. 3;

FIGS. 5 to 7 are operational side views of the machine for vamp shaping in FIG. 1; and

FIG. 8 is a perspective view of a second embodiment of a machine for vamp shaping in accordance with the present invention.

### DETAILED DESCRIPTION OF THE PREFERRED EMBODIMENT

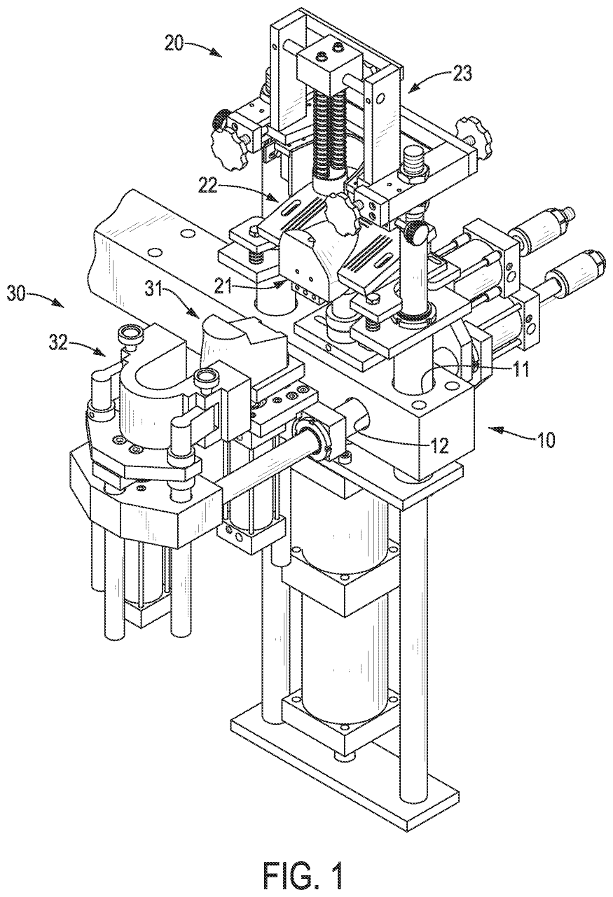

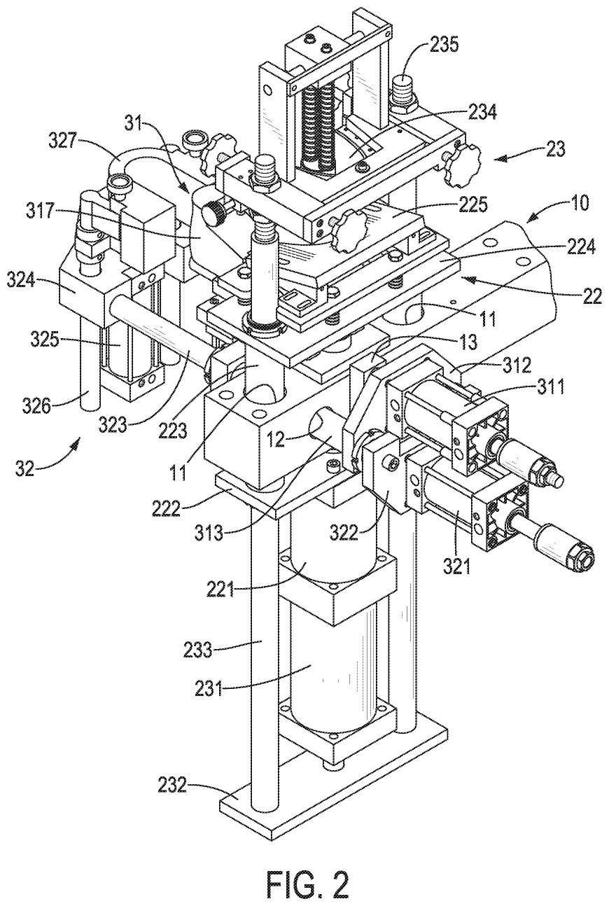

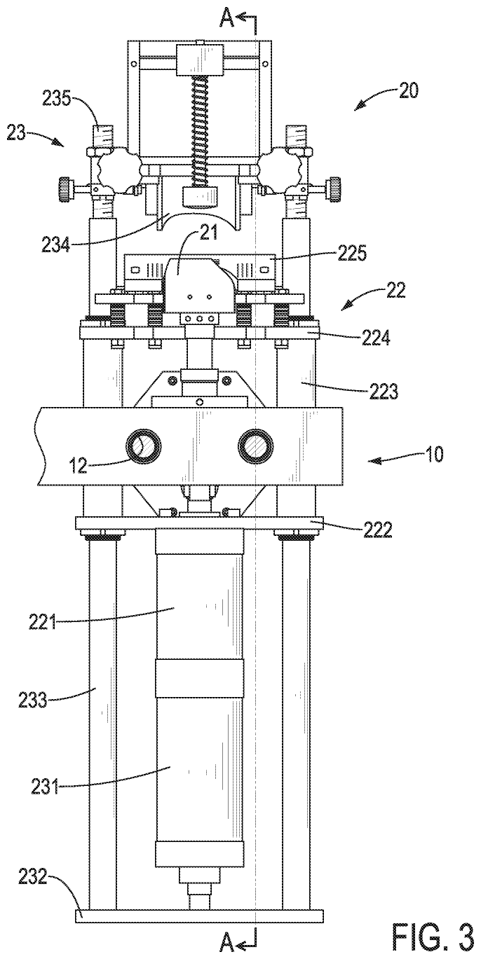

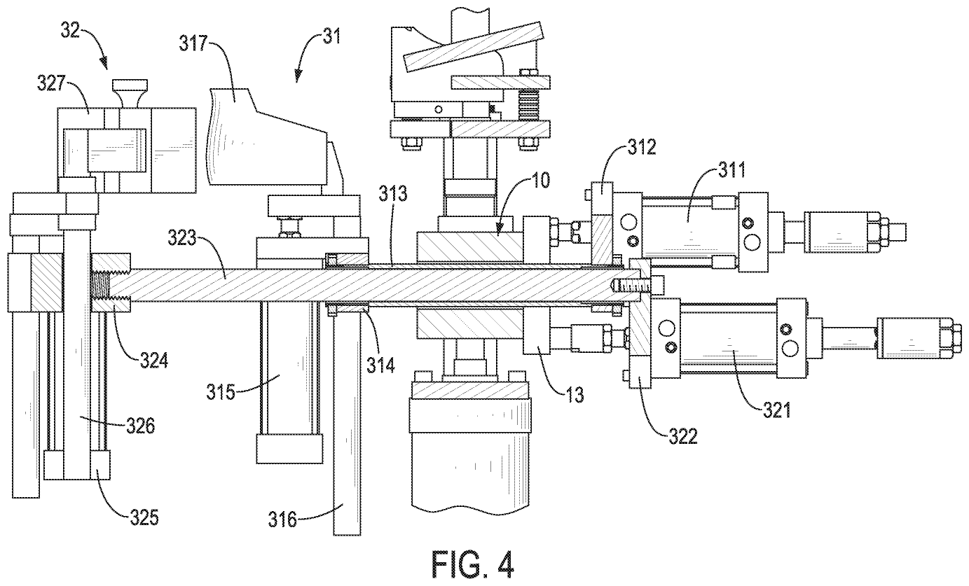

With reference to FIGS. 1 to 4, a first embodiment of a machine for vamp shaping comprises a body 10, a vertical device 20, and a horizontal device 30, wherein the vertical device 20 and the horizontal device 30 are respectively mounted to the body 10 and intersect with each other.

The body 10 is a horizontally disposed bar connected to a shell of the machine for vamp shaping, and has at least two vertical holes 11 and at least two horizontal holes 12. In the present embodiment, the body 10 has two vertical holes 11, two horizontal holes 12, and a connector 13.

The two vertical holes 11 are respectively formed along a height direction through the body 10 at a spaced interval. The two horizontal holes 12 are respectively formed along a horizontal direction through the body 10 at a spaced interval. The interval between the two horizontal holes 12 is shorter than the interval between the two vertical holes 11, so locations of the two horizontal holes 12 are within an area between the two vertical holes 11. The connector 13 is connected to a side of the body 10 and is located between the two horizontal holes 12.

With reference to FIGS. 1 to 3, the vertical device 20 is mounted to the body 10 along the height direction through the two vertical holes 11. The vertical device 20 has a toe-cap inner mold 21, a vamp locating module 22, and a toe-cap upper module 23.

The toe-cap inner mold 21 is mounted to a top side of the body 10 and is located between the two vertical holes 11.

The vamp locating module 22 is mounted to the two vertical holes 11, and has a locating cylinder 221, a locating guide 222, two vertical outer tubes 223, a locating connector 224, and a vamp locating board 225. The locating cylinder 221 is connected to a bottom side of the body 10. The locating cylinder 221 has a locating piston rod protruding upwardly. The locating piston rod of the locating cylinder 221 is mounted to the bottom side of the body 10, and aligns with the toe-cap inner mold 21. The locating guide 222 is mounted to the locating cylinder 221, and is located below the body 10 and parallel with the body 10. The two vertical outer tubes 223 are slidably mounted to the body 10 through the two vertical holes 11, respectively. Each one of the two vertical outer tubes 223 has a top end and a bottom end. The two vertical outer tubes 223 move simultaneously by their bottom ends linked to the locating guide 222. The locating connector 224 is linked to the top ends of the two vertical outer tubes 223. The vamp locating board 225 is linked to a top of the locating connector 224. The vamp locating board 225 is U-shaped and surrounds the toe-cap inner mold 21.

The toe-cap upper module 23 is mounted to the vamp locating module 22. The toe-cap upper module 23 has a toe-cap shaping cylinder 231, a toe-cap shaping guide 232, two vertical inner tubes 233, and a toe-cap outer mold 234.

The toe-cap shaping cylinder 231 is mounted to the locating cylinder 221, and has a piston rod protruding downwardly. The toe-cap shaping guide 232 is mounted to the piston rod of the toe-cap shaping cylinder 231. The two vertical inner tubes 233 slidably pass through the two vertical outer tubes 223, respectively. Each one of the two vertical inner tubes 233 has a bottom end and a top end. The bottom ends of the two vertical inner tubes 233 are mounted to the toe-cap shaping guide 232, so the two vertical inner tubes 233 move simultaneously along with the toe-cap shaping guide 232. The top ends are formed as a screw thread 235. The toe-cap outer mold 234 is connected to the two vertical inner tubes 233 through the screw threads 235.

With reference to FIGS. 1, 2, and 4, the horizontal device 30 is mounted to the body 10 along the horizontal direction through the two horizontal holes 12, and is spaced from the vertical device 20. The horizontal device 30 has a heel-cap inner module 31 and a heel-cap outer module 32.

The heel-cap inner module 31 has an inner cylinder 311, an inner guide 312, two horizontal outer tubes 313, an inner connector 314, an inner elevatable cylinder 315, an inner linking component 316, and a heel-cap inner mold 317.

The inner cylinder 311 is perpendicularly mounted to the body 10 along the horizontal direction, and has a piston rod that protrudes and is mounted to the connector 13. The inner guide 312 is mounted to the inner cylinder 311. The two horizontal outer tubes 313 are slidably mounted to the body 10 through the two horizontal holes 12. Each one of the two horizontal outer tubes 313 has one of two ends mounted to the inner guide 312, so the two horizontal outer tubes 313 may move simultaneously along with the inner guide 312. The inner connector 314 is mounted to the other one of the two ends of each horizontal outer tube 313.

The inner elevatable cylinder 315 is mounted to the inner connector 314, and has a piston rod protruding upwardly. The inner linking component 316 is up-and-down slidably mounted to the inner connector 314, and is connected to the piston rod of the inner elevatable cylinder 315. The heel-cap inner mold 317 is mounted on a top of the inner linking component 316.

The heel-cap outer module 32 has an outer cylinder 321, an outer guide 322, two horizontal inner tubes 323, an outer connector 324, an outer elevatable cylinder 325, an outer linking component 326, and a heel-cap outer mold 327.

The outer cylinder 321 is mounted to the body 10 below the inner cylinder 311, and has a piston rod that protrudes and is mounted to the connector 13. The outer guide 322 is mounted to the outer cylinder 321. The two horizontal inner tubes 323 slidably pass through the two horizontal outer tubes 313, respectively. In addition, each one of the two horizontal inner tubes 323 has one of two ends mounted to the outer guide 322, so the two horizontal inner tubes 323 may move simultaneously along with the outer guide 322. The outer connector 324 is mounted to the other one of the two ends of each horizontal inner tube 323.

The outer elevatable cylinder 325 is mounted to the outer connector 324, and has a piston rod protruding upwardly. The outer linking component 326 is up-and-down slidably mounted to the outer connector 324, and is connected to the piston rod of the outer elevatable cylinder 325. The heel-cap outer mold 327 is mounted on a top of the outer linking component 326.

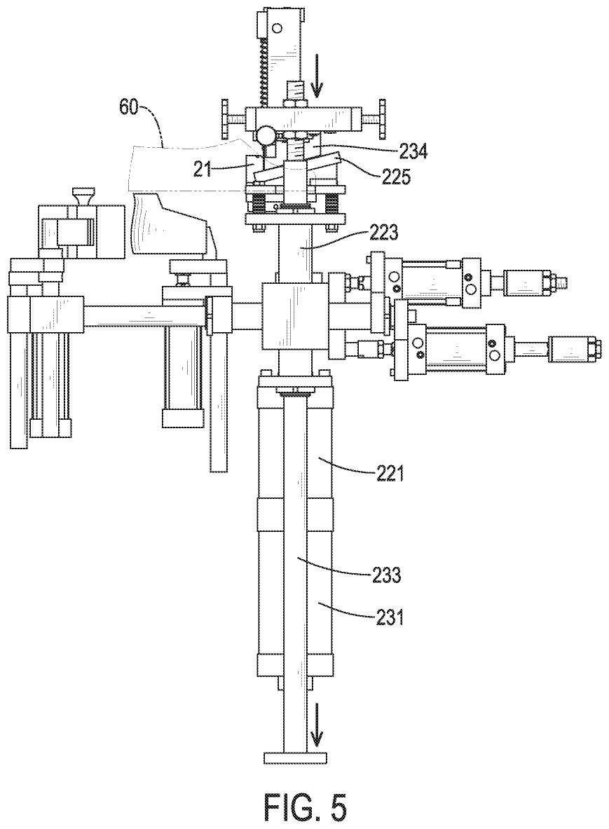

With reference to FIGS. 5 to 7, when operating the machine for vamp shaping, an operator may firstly wrap a vamp 60 on the toe-cap inner mold 21. As shown in FIG. 5, then the piston rods of the locating cylinder 221 and the toe-cap shaping cylinder 231 are respectively extended out, and drive the two vertical outer tubes 223 and the two vertical inner tubes 233 to move downwardly. As a result, the vamp locating board 225 and the toe-cap outer mold 234 may move downwardly as well, and then clamp the vamp 60 with the toe-cap inner mold 21 to accomplish the toe-cap shaping of the vamp 60.

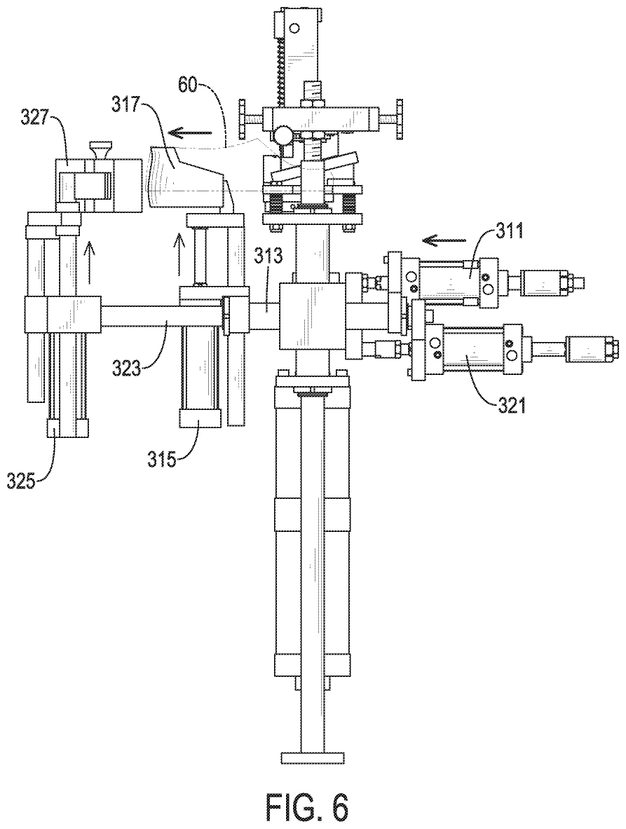

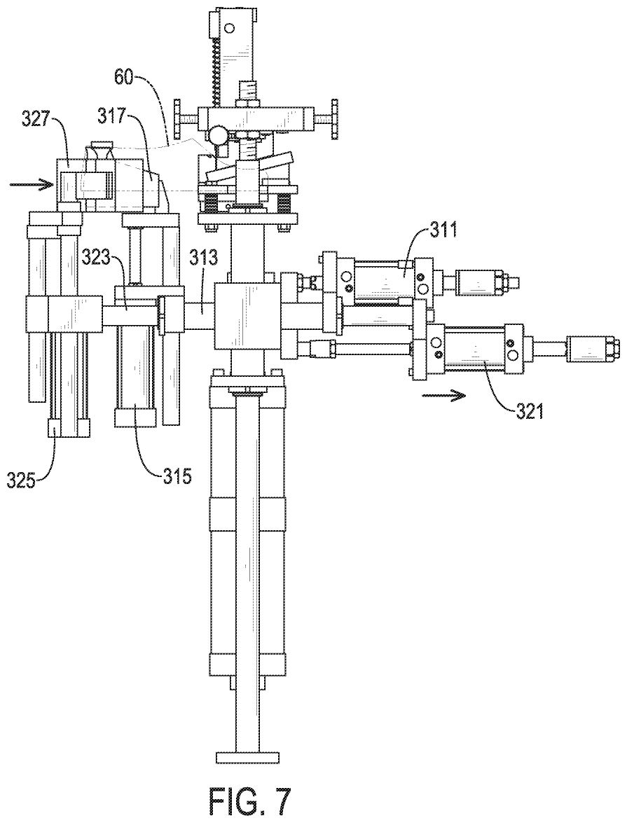

With reference to FIGS. 6 and 7, as the vamp 60 is clamped, the inner elevatable cylinder 315 and the outer elevatable cylinder 325 extend the corresponding piston rods out to raise the heel-cap inner mold 317 and the heel-cap outer mold 327 to the height of the toe-cap inner mold 21, via corresponding linking components 316, 326. At this time, the heel-cap inner mold 317 has protracted into the vamp 60. Furthermore, the inner cylinder 311 may retract the piston rod of the inner cylinder 311, so, via the two horizontal outer tubes 313, the heel-cap inner mold 317 may move against the toe-cap inner mold 21 to stretch the vamp 60.

Moreover, with reference to FIG. 7, after the vamp 60 is well stretched to be smooth, the outer cylinder 321 may protrude the piston rod of the outer cylinder 321 to pull back the heel-cap outer mold 327 via the two horizontal inner tubes 323. Therefore, a side of the vamp 60 away from the toe-cap inner mold 21 may be clamped by the heel-cap outer mold 327 and the heel-cap inner mold 317. Then the heel-cap shaping of the vamp 60 may be finished.

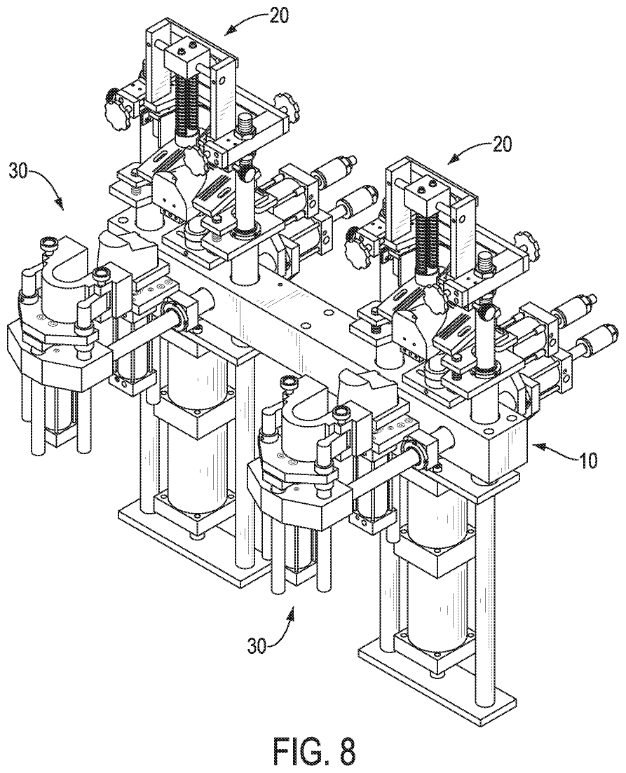

With reference to FIG. 8, a second embodiment of the machine for vamp shaping differs from the first embodiment in that: the machine for vamp shaping of the second embodiment comprises a body 10, two vertical devices 20, and two horizontal devices 30. The two vertical devices 20 are mounted to the body 10 in a height direction, respectively. The two horizontal devices 30 are perpendicularly mounted to the body 10 in a horizontal direction, and perpendicularly correspond to the two vertical devices 20, respectively.

With the aforementioned technical features, the machine for vamp shaping has the following advantages.

1. The machine enables the workers to easily accomplish the toe-cap shaping and the heel-cap shaping of the vamp 60 in series, and thus effectively simplifies the complex procedures of vamp shaping.

2. The machine resolves the problem of high equipment cost and space occupation. The components of the machine work in precise spatial arrangement, so shoemakers may use the machine in a limited space.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A machine for vamp shaping, the machine comprising:
a body having
at least two vertical holes disposed through the body at a spaced interval; and
at least two horizontal holes disposed through the body at a spaced interval;
at least one vertical device mounted to the body via the at least two vertical holes, and each one of the at least one vertical device having
a toe-cap inner mold mounted to the body;
a vamp locating module movably mounted to the at least two vertical holes, and located near the toe-cap inner mold; and
a toe-cap upper module movably mounted to the vamp locating module, and located above the toe-cap inner mold; and
at least one horizontal device mounted to the body via the at least two horizontal holes, and each one of the at least one horizontal device having
a heel-cap inner module movably mounted to the at least two horizontal holes; and
a heel-cap outer module movably mounted to the heel-cap inner module and located beside the heel-cap inner module and away from the body.

2. The machine as claimed in claim 1, wherein
the vamp locating module has
a locating cylinder mounted to the body;
two vertical outer tubes slidably mounted to the body through the at least two vertical holes, and connected to the locating cylinder; and
a vamp locating board connected to the two vertical outer tubes;
the toe-cap upper module has
a toe-cap shaping cylinder connected to the locating cylinder;
two vertical inner tubes slidably passing through the two vertical outer tubes, and connected to the toe-cap shaping cylinder; and
a toe-cap outer mold connected to the two vertical inner tubes;
the heel-cap inner module has
an inner cylinder connected to the body;
two horizontal outer tubes slidably mounted to the body through the at least two horizontal holes, and connected to the inner cylinder;
an inner elevatable cylinder connected to the two horizontal outer tubes, and having a piston rod; and
a heel-cap inner mold connected to the piston rod of the inner elevatable cylinder; and
the heel-cap outer module has
an outer cylinder connected to the body;
two horizontal inner tubes slidably passing through the two horizontal outer tubes, respectively, and connected to the outer cylinder;
an outer elevatable cylinder connected to the two horizontal inner tubes, and having a piston rod; and
a heel-cap outer mold connected to the piston rod of the outer elevatable cylinder.

3. The machine as claimed in claim 2, wherein
the body has
four said vertical holes disposed through the body at spaced intervals; and
four said horizontal holes disposed through the body at spaced intervals;
two said vertical devices mounted to the body at a spaced interval via the four vertical holes, respectively; and
two said horizontal devices mounted to the body at a spaced interval via the four horizontal holes, and corresponding to the two vertical devices, respectively.

4. The machine as claimed in claim 2, wherein the heel-cap inner module further has
an inner guide connecting the inner cylinder and the two horizontal outer tubes;
an inner connector connecting the two horizontal outer tubes and the inner elevatable cylinder; and
an inner linking component connecting the heel-cap inner mold and the piston rod of the inner elevatable cylinder.

5. The machine as claimed in claim 4, wherein the heel-cap outer module further has
an outer guide connecting the outer cylinder and the two horizontal inner tubes;
an outer connector connecting the two horizontal inner tubes and the outer elevatable cylinder; and
an outer linking component connecting the heel-cap outer mold and the piston rod of the outer elevatable cylinder.

6. The machine as claimed in claim 5, wherein the toe-cap upper module further comprises a toe-cap shaping guide connecting the toe-cap shaping cylinder and the two vertical inner tubes.

7. The machine as claimed in claim 6, wherein each one of the two vertical inner tubes has a screw thread at a top end of the vertical inner tube.

8. The machine as claimed in claim 7, wherein the vamp locating module further comprises
a locating guide connecting the locating cylinder and the two vertical outer tubes; and
a locating connector connecting the two vertical outer tubes and the vamp locating board.

9. The machine as claimed in claim 8, wherein the body has a connector connected to the inner cylinder and the outer cylinder.

10. The machine as claimed in claim 3, wherein the heel-cap inner module of each one of the two horizontal modules further comprises
an inner guide connecting the inner cylinder and the two horizontal outer tubes;
an inner connector connecting the two horizontal outer tubes and the inner elevatable cylinder; and
an inner linking component connecting the heel-cap inner mold and the piston rod of the inner elevatable cylinder.

11. The machine as claimed in claim 10, wherein the heel-cap outer module of each one of the two horizontal modules further comprises
an outer guide connecting the outer cylinder and the two horizontal inner tubes;
an outer connector connecting the two horizontal inner tubes and the outer elevatable cylinder; and
an outer linking component connecting the heel-cap outer mold and the piston rod of the outer elevatable cylinder.

12. The machine as claimed in claim 11, wherein the toe-cap upper module of each one of the two vertical devices further comprises a toe-cap shaping guide connecting the toe-cap shaping cylinder and the two vertical inner tubes.

13. The machine as claimed in claim 12, wherein each one of the vertical inner tubes has a screw thread at a top end of the vertical inner tube.

14. The machine as claimed in claim 13, wherein the body has a connector connected to the inner cylinder and the outer cylinder.

15. The machine as claimed in claim 1, wherein
the body has
four said vertical holes disposed through the body at spaced intervals; and
four said horizontal holes disposed through the body at spaced intervals;
two said vertical devices mounted to the body at spaced intervals via the four vertical holes, respectively; and
two said horizontal devices mounted to the body at spaced intervals via the four horizontal holes, and corresponding to the two vertical devices, respectively.
